(19) United States
(12) Patent Application Publication
(10) Pub. No.: US 2020/0191821 A1
(43) Pub. Date: Jun. 18, 2020

(54) COMPACT LIDAR SYSTEM

(71) Applicant: THALES, COURBEVOIE (FR)

(72) Inventors: Philippe RONDEAU, VALENCE (FR); Xavier LACONDEMINE, VALENCE (FR)

(21) Appl. No.: 16/711,346

(22) Filed: Dec. 11, 2019

(30) Foreign Application Priority Data
Dec. 18, 2018 (FR) 1873152

(51) Int. Cl. G01P 5/26; G01S 7/481

(52) U.S. Cl. CPC G01P 5/26; G01S 7/4813; G01S 7/4817

(57) ABSTRACT

An airborne compact anemometric lidar system includes a laser that can emit a laser beam, an optical system suitable for forming the laser beam emitted by the laser, an optical window that is transparent to the laser radiation emitted by the laser, wherein the lidar system comprises a first prism and a second prism, the first prism being fixed and configured to deflect the laser beam formed by the optical system, the second prism being mounted on a rotation device configured to perform a rotation about the axis of propagation of the laser beam transmitted by the first prism, so that a laser beam deflected by the second prism passes through the optical window by forming, with the normal \vec{n} to the optical window, a non-zero angle, the angle between the optical axis of the optical system and the normal \vec{n} being less than 10°, the rotation device being driven by a circuit that makes it possible to orient the second prism so as to select the angle with which the laser beam passes through the window.

### CROSS-REFERENCE TO RELATED APPLICATIONS

This application claims priority to foreign French patent application No. FR 1873152, filed on Dec. 18, 2018, the disclosure of which is incorporated by reference in its entirety.

### FIELD OF THE INVENTION

The invention relates to an anemometric lidar device intended for the aeronautical field.

### BACKGROUND

Maintaining an aircraft in flight entails knowing a certain number of fundamental parameters such as its relative altitude, its speed relative to the ambient air mass and its angle of incidence.

The lidar anemometry devices make it possible to measure, for example, the relative air speed at a point situated at a small distance from the aeroplane skin without requiring physical protuberance. Speed measurement by anemometric lidar is based on the measurement of the frequency shift, by Doppler effect, between a laser beam emitted into the atmosphere and the beam backscattered by the aerosols naturally present in the air.

FIG. 1 represents an anemometric lidar for aeronautical measurement known from the prior art. This lidar comprises a laser system 10 that can emit a laser beam 4 at a certain wavelength and comprises an optical focusing system 5 suitable for focusing the laser beam 4. The laser beam backscattered by atmospheric particles is directed towards a heterodyne detection in which the beat with a so-called local oscillator laser radiation makes it possible to generate an electrical signal whose frequency is equal to the frequency shift linked to the Doppler effect. Since the Doppler shift is proportional to the projection of the relative speed of the aerosols on the axis of the beam from the lidar, it is then possible to calculate the radial speed of the air mass. In FIG. 1, the laser beam 4 is emitted by the laser through an optical window 3 (or porthole) which is transparent to the wavelength of the laser radiation. In order to ensure that the optical window 3 is level with the skin of the aircraft, the latter is mounted on a plate 2.

In order to measure aircraft-relevant anemometric speeds, it is generally desirable to orient the laser system 10 so that the axis of propagation of the laser beam 4 forms a non-zero angle with the normal to the skin of the aircraft at the chosen point of installation of the lidar 1. For that, the preferential solution is to incline the optical axis of the focusing system 5 of the optical beam 4 relative to the normal to the interface porthole 3 inside the lidar equipment.

However, that involves difficulties in integration of the elements and reduces the re-usability of a lidar device design. Indeed, it is not possible to modify the orientation of the beam passing through the porthole without designing a different opto-mechanical arrangement.

Moreover, modifying the angle of the beam outside of the device involves re-designing electronic circuit boards whose form must be adapted to a new internal footprint of the lidar device 1.

Finally, the internal inclination of the optical system 5 within the device 1 limits the compactness of the lidar equipment through the separation—according to the axis of propagation of the beam—that is necessary between the optical system and the optical window in order for the laser beam formed by the optical system to pass through the optical window.

All these parameters considerably increase the cost of the anemometric lidar systems.

### SUMMARY OF THE INVENTION

The invention aims to partly resolve the abovementioned problems of the prior art, that is to say that the subject of the invention is an anemometric lidar system of great compactness.

One subject of the invention is an airborne compact anemometric lidar system comprising, a laser that can emit a laser beam, an optical system suitable for forming the laser beam emitted by the laser, an optical window that is transparent to the laser radiation emitted by the laser, characterized in that the lidar system comprises a first prism and a second prism, said first prism being fixed and configured to deflect the laser beam formed by the optical system, said second prism being mounted on a rotation device configured to perform a rotation about the axis of propagation of the laser beam transmitted by the first prism, so that a laser beam deflected by the second prism passes through the optical window by forming, with the normal \vec{n} to said optical window, a non-zero angle, the angle between the optical axis of the optical system and the normal \vec{n} being less than 10°, said rotation device being driven by a circuit that makes it possible to orient the second prism so as to select the angle with which the laser beam passes through the optical window.

According to particular embodiments of such a lidar system:
it comprises a plate on which the optical window is mounted, the plate being adapted for said optical window to be level with the skin of the carrier of the lidar system;
at least one prism is placed at a distance from the optical window less than 20% of the diameter of the optical window;
the prisms are oriented so that the laser beam passing through the prism or prisms is deflected with an angle corresponding to the minimum deflection of the prism or prisms;
the refractive index of the prisms is greater than 2;
the prisms are produced in silicon or in germanium;
the angle between the optical axis of the optical system (5) and the normal \vec{n} is zero.

### BRIEF DESCRIPTION OF THE DRAWINGS

Other features, details and advantages of the invention will emerge on reading the description given with reference to the attached drawings that are given by way of example and which represent, respectively:

FIG. 1, an anemometric lidar system for aeronautical measurement from the prior art.

FIG. 2, a compact anemometric lidar system for aeronautical measurement according to a first embodiment of the prior art.

FIG. 3, a compact anemometric lidar system for aeronautical measurement according to a first embodiment of the invention.

FIG. 4, a compact anemometric lidar system for aeronautical measurement according to a first embodiment of the invention.

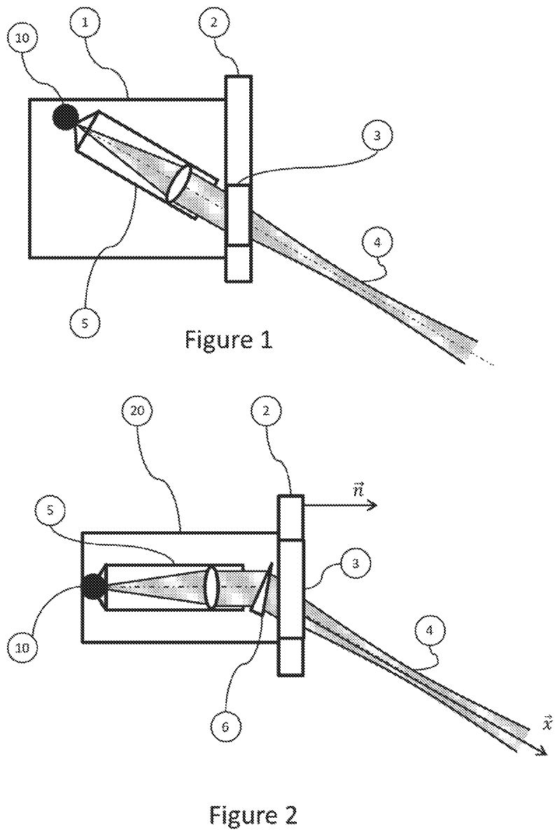

The references in the figures, when they are identical, correspond to the same elements.

In the figures, unless indicated otherwise, the elements are not to scale.

### DETAILED DESCRIPTION OF THE INVENTION

FIG. 2 illustrates a compact anemometric lidar system 20 for aeronautical measurement according to a first embodiment of the prior art. This lidar system 20 is embedded on an aircraft and comprises a laser 10 that can emit a laser beam 4.

The lidar 20 comprises an optical system 5 suitable for forming the laser beam 4 emitted by the laser and an optical window 3 that is transparent to the laser radiation emitted by the laser. In the embodiment of FIG. 2, the radiation emitted by the laser 10 has a wavelength lying between 1.4 μm and 1.7 μm. In order to ensure the conformity of the optical window 3 with the skin of the aircraft, the latter is mounted on a plate 2. Transparent is understood here to mean a transmission greater than 90%. The optical window 3 is mounted on a plate 2 in order to ensure that the optical window is level with the skin of the aircraft.

In order to determine relevant anemometrics speeds, the lidar system 20 comprises, in addition, at least one prism 6 configured to deflect the laser beam formed by the optical system, so that it passes through the optical window 3 by forming, with the normal \vec{n} to said optical window, a non-zero angle. Since the porthole 3 is mounted on the plate 2, that is tantamount to saying that the prism is configured so that the axis of propagation x of the laser beam 4 deflected by the prism and passing through the optical window is not parallel to the normal \vec{n} of the skin of the carrier at the zone or point of installation of the lidar system. In the embodiment of FIG. 2, the angle between the axis of propagation of the laser beam and the normal \vec{n} of the skin of the carrier, called angle of emergence, is less than 45°. It is preferable to keep this angle less than 45° because the high-incidence anti-reflection treatments are more difficult to produce and more costly. Furthermore, a significant incidence means a strong shift between the points of input and of output of the beam on the porthole causing the porthole to be enlarged. Prism is understood to mean a transmissive element having two planar and non-parallel opposing faces. In the embodiment of FIG. 2, the lidar system comprises a single prism. The prism is configured so that the axis of propagation x of the laser beam 4 deflected by the prism and passing through the optical window is not parallel to the normal n of the skin of the carrier at the zone or at the point of installation of the lidar system. The optical system is configured so that the angle formed by the optical axis and the normal \vec{n} to the optical window is less than 10° and preferentially zero. This angle is the smallest possible angle for the footprint of the optical system in the lidar system to be the smallest possible.

The use of such a prism makes it possible to choose the orientation of the axis of the optical system 5 in the lidar system 20 independently of the orientation of the beam outside the equipment. This allows for a gain in compactness of the lidar system 20 by reducing the useful volume losses. Indeed, by contrast with the lidar devices of the prior art, it is then no longer necessary to incline the axis of the optical system and/or of the laser system in order to obtain a non-zero angle between the axis of propagation of the laser beam 4 and the normal to the skin of the aircraft at the chosen point of installation of the lidar system.

Furthermore, the use of a prism favours the multipurpose nature of the equipment by allowing a modification of the orientation of the beam outside of the aircraft simply by changing the prism used (for example, by replacing it with a prism having a different angle between its faces) without having to adjust the internal optical, mechanical and electronic architecture of the lidar system. It is also possible to turn the prism 6 about the optical axis of the optical system 5 in order to modify the plane formed by the axis of propagation x of the beam and the normal n to the optical window.

The prism therefore makes it possible to maximize the common elements between the lidar systems positioned at different locations on one and the same carrier or even between the lidar systems embedded on different carriers. These advantages allow for a considerable lowering of the cost of the lidar system 20.

The prism is produced in a material that is transparent to the laser radiation emitted by the laser 10 and that has a high refractive index (typically greater than 2) in order to limit the size and the angle of the prism necessary to deflect the beam and minimize the optical aberrations on the transmitted beam. For laser wavelengths lying between 1.4 and 1.7 μm, the prism will for example be able to be produced in silicon (Si, n≈3.5) or in germanium (Ge n≈4.3).

Preferentially, the prism is oriented so as to be used at its minimum deflection in order to minimize the aberrations provoked on the laser beam 4 by passing through said prism.

The prism 6 is placed at a distance that is as small as possible from the optical window in order to reduce to the maximum the space necessary between the axis of the optical system and the useful zone of the optical window (zone where the laser beam passes through). Placing the prism as close as possible to the porthole therefore makes it possible to reduce the volume of the lidar system. It will however be necessary to avoid contact with the optical window, throughout the provided environmental field of the system, because this contact could lead to deterioration of the surfaces. In the embodiment of FIG. 2, the prism is placed at a distance from the optical window less than 20% of the diameter of the optical window.

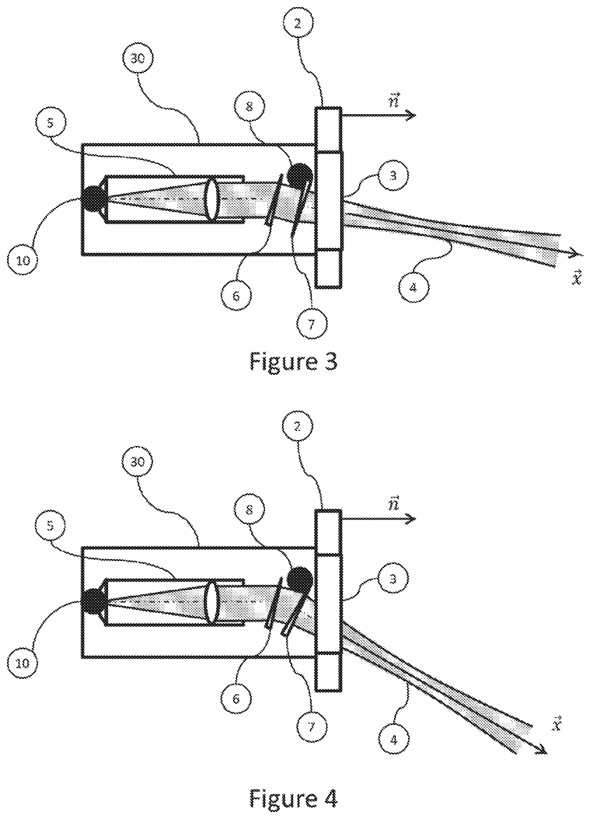

FIGS. 3 and 4 illustrate a compact anemometric lidar system 30 for aeronautical measurement according to a first embodiment of the invention. In this embodiment the lidar system comprises two prisms, a first prism 6 configured to deflect the laser beam formed by the optical system 5 and a second prism 7 mounted on a rotation device 8 configured to perform a rotation about the axis of propagation of the laser beam transmitted by the first prism 6. The first prism 6 and the second prism 7 are placed so as to be used at their minimum deflection in order to minimize the aberrations provoked on the laser beam 4 by the passage through the two prisms. The rotation device is driven by a circuit (not represented in FIG. 3) that makes it possible to orient the second prism so as to control and vary the angle with which the laser beam 4 passes through the optical window while minimizing the optical aberrations thereof. In the embodiment of FIG. 3, the orientation of the prism 7 is chosen so as to minimize the angle of emergence on the optical window. In the embodiment of FIG. 4, the orientation of the prism is chosen so as to maximize the angle of emergence.

1. An airborne compact anemometric lidar system comprising, a laser that can emit a laser beam, an optical system suitable for forming the laser beam emitted by the laser, an optical window that is transparent to the laser radiation emitted by the laser, wherein the lidar system comprises a first prism and a second prism, said first prism being fixed and configured to deflect the laser beam formed by the optical system, said second prism being mounted on a rotation device configured to perform a rotation about the axis of propagation of the laser beam transmitted by the first prism, so that a laser beam deflected by the second prism passes through the optical window by forming, with the normal \vec{n} to said optical window, a non-zero angle, the angle between the optical axis of the optical system and the normal \vec{n} being less than 10°, said rotation device being driven by a circuit that makes it possible to orient the second prism so as to select the angle with which the laser beam (4) passes through the optical window.

2. The compact anemometric lidar system according to claim 1, comprising a plate wherein the optical window is mounted, the plate being adapted for said optical window to be level with the skin of the carrier of the lidar system.

3. The compact anemometric lidar system according to claim 1, wherein at least one prism is placed at a distance from the optical window less than 20% of the diameter of the optical window.

4. The compact anemometric lidar system according to claim 1, wherein the prisms are oriented so that the laser beam passing through the prisms is deflected with an angle corresponding to the minimum deflection of the prism or prisms.

5. The compact anemometric lidar system according to claim 1, wherein the refractive index of the prisms is greater than 2.

6. The compact anemometric lidar system according to claim 1, wherein the prisms are produced in silicon or in germanium.

7. The compact anemometric lidar system according to claim 1, wherein the angle between the optical axis of the optical system and the normal \vec{n} is zero.
